(19) United States
(12) Patent Application Publication
(10) Pub. No.: US 2024/0143746 A1
(43) Pub. Date: May 2, 2024

(54) CONTEXT AWARE BEHAVIORAL ANOMALY DETECTION IN COMPUTING SYSTEMS

(71) Applicant: VMware LLC, Palo Alto, CA (US)

(72) Inventors: Raghav BATTA, Livermore, CA (US); Amit CHOPRA, Cedar Park, TX (US); Aditya CHOUDHARY, San Jose, CA (US); Lalit Prithviraj JAIN, Cupertino, CA (US); Anjali MANGAL, Cupertino, CA (US); Jonathan James OLIVER, Victoria (AU)

(73) Assignee: VMware LLC, Palo Alto, CA (US)

(21) Appl. No.: 17/976,672

(22) Filed: Oct. 28, 2022

(51) Int. Cl. G06F 21/55; G06F 21/52

(52) U.S. Cl. CPC G06F 21/554; G06F 21/52; G06F 2221/034

(57) ABSTRACT

Systems and methods are described for employing event context to improve threat detection. Systems and methods of embodiments of the disclosure measure both process deviation and path deviation to determine whether processes are benign or represent threats. Both a process deviation model and a path deviation model are deployed. The process deviation model determines the similarity of a process to past processes, and the path deviation model estimates whether processes have been called out of turn. In this manner, systems and methods of embodiments of the disclosure are able to detect both whether a process is in itself unusual, and whether it is called at an unusual time. This added context contributes to improved threat detection.

### FIELD

The present disclosure relates generally to threat detection in computing systems. More specifically, the present disclosure relates to context aware behavioral anomaly detection in computing systems.

### BACKGROUND

Contemporary cybersecurity systems face a number of significant challenges. Mimicry attacks may be difficult to distinguish from benign processes. Many rule-based systems either fail to detect novel attacks or, in attempts to catch them, employ broad rules that generate excessive false positives. And it is estimated that false positives cause approximately the same system downtime as actual attacks. In some estimates, as many as three quarters of organizations spend as much time dealing with false positive attacks as with actual security events. Significant efforts thus continue to be directed towards overcoming these and other challenges.

### SUMMARY

In some embodiments of this disclosure, systems and methods are described for employing event context to improve threat detection. Systems and methods of embodiments of the disclosure measure both process deviation and path deviation to determine whether processes are benign or represent threats. Both a process deviation model and a path deviation model are employed. The process deviation model determines the similarity of a process to past processes, and the path deviation model estimates whether processes have been called out of turn. In this manner, systems and methods of embodiments of the disclosure are able to detect both whether a process is in itself unusual, and whether it is called at an unusual time. This added context contributes to improved threat detection. For example, by focusing on process level deviation and path level deviation rather than mere similarity to past attacks, novel attacks are more readily detected. Similarly, as path deviation is analyzed in addition to process deviation, mimicry attacks which have only superficial differences from malicious paths are more likely to be detected.

In some embodiments of the disclosure, a method of detecting anomalous behavior in a distributed computing system may include detecting a computational process carried out by one or more programs executed on the distributed computing system, and determining whether the detected computational process is an anomalous computational process, according to a deviation between the detected computational process and a cluster of previously detected computational processes. The method may also include determining a computational process path comprising a plurality of the detected computational processes, each detected computational process of the plurality of the detected computational processes calling another detected computational process of the plurality of the detected computational processes, and determining whether the determined computational process path is an anomalous computational process path, according to a frequency at which a transition from one process of the computational process path to another process of the computational process path has occurred. The method may also include transmitting an alert in response to determining that the detected computational process is an anomalous computational process, and in response to determining that the detected computational process path is determined to be an anomalous computational process path.

In some other embodiments of the disclosure, a non-transitory computer-readable storage medium is described. The computer-readable storage medium includes instructions configured to be executed by one or more processors of a computing device and to cause the computing device to carry out steps that include: detecting a computational process carried out by one or more programs executed on the distributed computing system; determining whether the detected computational process is an anomalous computational process, according to a deviation between the detected computational process and a cluster of previously detected computational processes; determining a computational process path comprising a plurality of the detected computational processes, each detected computational process of the plurality of the detected computational processes calling another detected computational process of the plurality of the detected computational processes; determining whether the determined computational process path is an anomalous computational process path, according to a frequency at which a transition from one process of the computational process path to another process of the computational process path has occurred; and transmitting an alert in response to determining that the detected computational process is an anomalous computational process, and in response to determining that the detected computational process path is determined to be an anomalous computational process path.

In some other embodiments of the disclosure, a computer system comprises one or more processors; and memory storing one or more programs configured to be executed by the one or more processors. The one or more programs include instructions for: detecting a computational process carried out by one or more programs executed on the distributed computing system; determining whether the detected computational process is an anomalous computational process, according to a deviation between the detected computational process and a cluster of previously detected computational processes; determining a computational process path comprising a plurality of the detected computational processes, each detected computational process of the plurality of the detected computational processes calling another detected computational process of the plurality of the detected computational processes; determining whether the determined computational process path is an anomalous computational process path, according to a frequency at which a transition from one process of the computational process path to another process of the computational process path has occurred; and transmitting an alert in response to determining that the detected computational process is an anomalous computational process, and in response to determining that the detected computational process path is determined to be an anomalous computational process path.

Other aspects and advantages of embodiments of the disclosure will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 is a diagram illustrating an exemplary server cluster suitable for use with embodiments of the disclosure;

FIG. 2 is a block diagram representation of an exemplary event intake and storage system for use with embodiments of the disclosure;

FIG. 3 is a block diagram representation of another exemplary event intake and storage system for use with embodiments of the disclosure;

FIG. 4A conceptually illustrates embedding of processes for use in conjunction with embodiments of the disclosure;

FIG. 4B conceptually illustrates construction of paths for use in conjunction with embodiments of the disclosure;

FIG. 5 is a block diagram representation of a system for context aware behavioral anomaly detection, according to embodiments of the disclosure;

FIG. 6 is a block diagram representation of a system for training of models for context aware behavioral anomaly detection, according to embodiments of the disclosure; and

FIG. 7 is a flow chart depicting a method for context aware behavioral anomaly detection, according to embodiments of the disclosure.

### DETAILED DESCRIPTION

Certain details are set forth below to provide a sufficient understanding of various embodiments of the disclosure. However, it will be clear to one skilled in the art that embodiments of the disclosure may be practiced without one or more of these particular details, or with other details. Moreover, the particular embodiments of the present disclosure described herein are provided by way of example and should not be used to limit the scope of the disclosure to these particular embodiments. In other instances, hardware components, network architectures, and/or software operations have not been shown in detail in order to avoid unnecessarily obscuring the disclosure.

In some embodiments of the disclosure, systems and methods are described for employing event context to improve threat detection. Systems and methods of embodiments of the disclosure employ both a process deviation model and a path deviation model to detect threats. Computational processes are represented by their generated events, in any order. Paths contain representations of processes in the order in which each process calls the next. In some embodiments, the process deviation model is a clustering model trained to recognize clusters of previously-detected processes executed by a computing system. The clustering model thus determines a degree of deviation of newly-detected processes from these previously-determined process clusters, describing how similar any new processes are to previous processes of that computing system. Dissimilar processes may cause an alert to be generated. The path deviation model may be any model suitable for determining whether processes have been called out of turn. In some embodiments, the path deviation model may be a heuristic model employing one or more rule sets to determine whether a newly-detected process path is sufficiently unusual to trigger an alert. In some embodiments, the path deviation model may employ one or more machine learning models trained to recognize deviations from path norms. Paths which deviate sufficiently from established norms may cause an alert to be generated. In this manner, systems and methods of embodiments of the disclosure are able to detect both historically unusual processes, and processes that are called in an unusual manner. This added context contributes to improved threat detection.

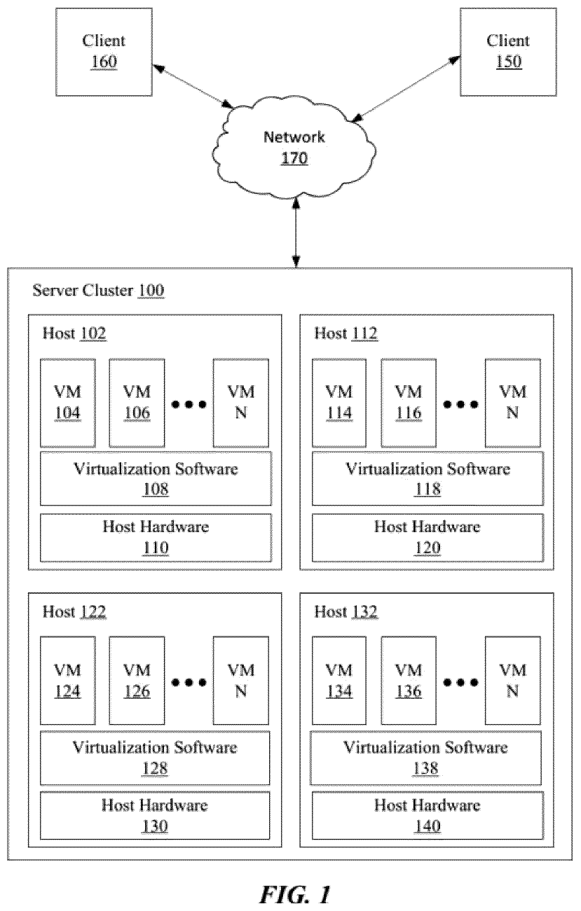

FIG. 1 is a diagram illustrating an exemplary server cluster suitable for use with embodiments of the disclosure. Server cluster 100 can include hosts 102, 112, 122 and 132. While a four host system is shown for exemplary purposes it should be appreciated that server cluster 100 could include a larger or smaller number of hosts. Each host 102-132 includes host hardware 110-140, which can include a designated amount of processing, memory, network and/or storage resources. In some embodiments, each of the hosts provide the same amount of resources, and in other embodiments, the hosts are configured to provide different amounts of resources to support one or more virtual machines (VMs) running on the hosts. Each of the VMs can be configured to run a guest operating system that allows for multiple applications or services to run within the VM.

Each of hosts 102, 112, 122 and 132 are capable of running virtualization software 108, 118, 128 and 138, respectively. The virtualization software can run within a virtual machine (VM) and includes management tools for starting, stopping and managing various virtual machines running on the host. For example, host 102 can be configured to stop or suspend operations of virtual machines 104 or 106 utilizing virtualization software 108. Virtualization software 108, commonly referred to as a hypervisor, can also be configured to start new virtual machines or change the amount of processing or memory resources from host hardware 110 that are assigned to one or more VMs running on host 102. Host hardware 110 includes one or more processors, memory, storage resources, I/O ports and the like that are configured to support operation of VMs running on host 102. In some embodiments, a greater amount of processing, memory or storage resources of host hardware 110 is allocated to operation of VM 104 than to VM 106. This may be desirable when, e.g., VM 104 is running a larger number of services or running on a more resource intensive operating system than VM 106. Clients 140 and 150 are positioned outside server cluster 100 and can request access to services running on server cluster 100 via network 160. Responding to the request for access and interacting with clients 140 and 150 can involve interaction with a single service or in other cases may involve multiple smaller services cooperatively interacting to provide information requested by clients 140 and/or 150.

Hosts 102, 112, 122 and 132, which make up server cluster 100, can also include or have access to a storage area network (SAN) that can be shared by multiple hosts. The SAN is configured to provide storage resources as known in the art. In some embodiments, the SAN can be used to store event data generated during operation of server cluster 100. While description is made herein with respect to the operation of the hosts 110-140, it will be appreciated that those of hosts 110-140 provide analogous functionality, respectively.

While FIG. 1 describes a computing system capable of implementing virtual applications on VMs, it may be observed that hosts 102, 112, 122 and 132 may also execute instances of application programs on their host hardware 110, 120, 130, 140 without use of any VMs. Accordingly, embodiments of the disclosure contemplate anomaly detection carried out by any application or other programs, whether run on a VM or otherwise.

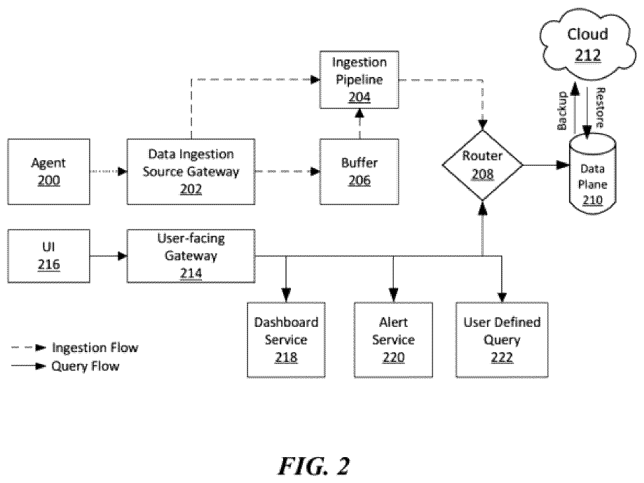

FIG. 2 is a block diagram representation of an exemplary event intake and storage system for use with embodiments of the disclosure. Agent 200 may include a sensor or any other computational network element capable of detecting and/or characterizing any portion of network traffic. Agent 200 can be incorporated into many different types of environments (e.g., as a cloud infrastructure, an on premises infrastructure, or in a specific embodiment server cluster 100) to transmit log data that is generated in response to many different types of events to data ingestion source gateway 202. For example, agent 200 can generate telemetry stored in an events table that represents various events that are captured during normal or irregular operation of agent 200. The telemetry could include any number of metadata and a time stamp that helps to determine how often particular types telemetry events are generated. The metadata could be used to help identify whether the telemetry events are related to, e.g., security events, detected errors, or more normal activity such as a login or file download event. Data ingestion source gateway 202 is configured to forward event data received from agent 200 to ingestion pipeline 204 and/or buffer 206. Event data received at ingestion pipeline 204 is then forwarded on to router 208, which distributes the event data to data plane 210. Event data can be sent to buffer 206 when a rate at which event data is being supplied by agent 200 exceeds a rate ingestion pipeline 204 can handle. In such a situation, buffer 206 may be a queue or any other suitable data structure for data storage and retrieval. As one example, buffer 206 can take the form of a Kafka module able to handle many extremely large streams of data. In some embodiments, the Kafka module can be configured to distribute multiple streams of the event data to separate computing resources to keep up with a rate at which the event data is being produced. Such a situation may arise when the system associated with agent 200 is undergoing high usage and/or experiencing large numbers of errors or warnings. Data plane 210 can be organized into multiple shards that improve reliability of the data store but may also limit a rate at which the stored log data can be retrieved. In some embodiments, the data can also be stored on a cloud service 212. Cloud service 212 can provide access to the event data during an on premise server outage or be used to restore data lost due to equipment failure.

A user is able to retrieve relevant subsets of the event data from data plane 210 by accessing user-facing gateway 214 by way of user interface 216. Data representative of the event data is obtained by dashboard service 218, alert service 220 and user-defined query module 222. Dashboard service 218 is generally configured to retrieve event data from data plane 210 within a particular temporal range or that has a particular log type. Dashboard service 218 can include a number of predefined queries suitable for display on a dashboard display. Dashboard service 218 could include conventional queries that help characterize metrics such as error occurrence, user logins, server loading, etc. Alert service 220 can be configured to alter the user when the event data indicates a serious issue and user-defined query module 222 allows a user to define custom queries particularly relevant to operation of the application associated with agent 200. With this type of configuration, dashboard service 218, alert service 220 and user-defined query module 222 each route requests for data to support the alerts and queries to data plane 210 by way of router 208. Queries are typically run to retrieve the entire dataset relevant to the query or alert in order to be sure time-delayed logs are not missed from the queries. In this way, the queries can be sure to obtain all data relevant to the query.

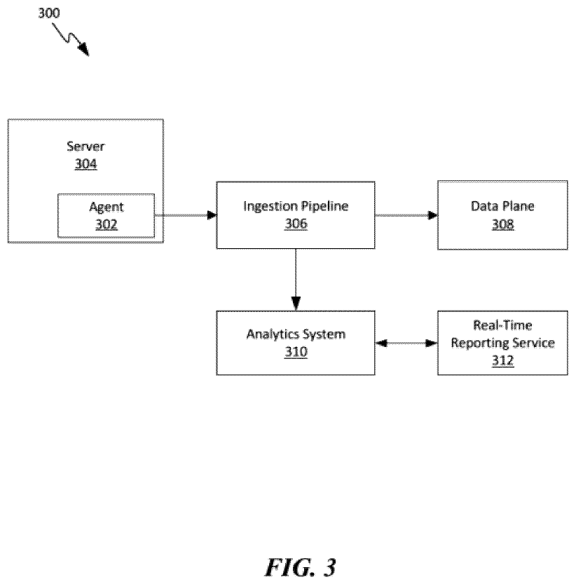

FIG. 3 is a block diagram representation of another exemplary event intake and storage system 300 for use with embodiments of the disclosure. In particular, agent 302 can be installed within operational system 304 and configured to transmit a stream of event data generated by operational system 304 to ingestion pipeline 306. In some embodiments, the connection between agent 300 and the ingestion pipeline 302 can be a direct connection or alternatively be transmitted across a larger network. Ingestion pipeline 302 can be configured to perform basic formatting and parsing operations upon the event data prior to transmitting the event data to data plane 308. In some embodiments, the event data stored in data plane 308 can be backed up to other servers located on premises or at a number of distributed cloud computing facilities. Ingestion pipeline 306 can also be configured to provide data to analytics data storage 308. Analytics system 310 can include a robust set of filters that processes only the event data pertaining to a current set of metrics requested from real-time display system 310. For example, when processing the event data, any event data files failing to match one or more event data criteria can be discarded to save space and reduce access time to the event data stored on analytics data storage 308. In some embodiments, event data that is saved can be reduced in size by including only metrics currently being requested by real-time reporting service 312. Saving only a subset of the event data relevant to what is currently being used by the real-time reporting service during the data ingestion process allows for much more rapid performance of the system 300. In some embodiments, the speed of real-time reporting service 312 is increased by at least an order of magnitude when compared with a configuration similar to the one depicted in FIG. 2.

Analytics system 310 may be in electronic communication with any other network elements. For example, analytics system 310 may access the above described SAN, or may access data plane 210 to compile the above described table of most commonly occurring file paths and their associated hash values. System 310 may also access any network-accessible service to replace tabulated most commonly occurring file paths in received alerts, and transmit them to, e.g., a feature store for application identification, threat identification, or the like.

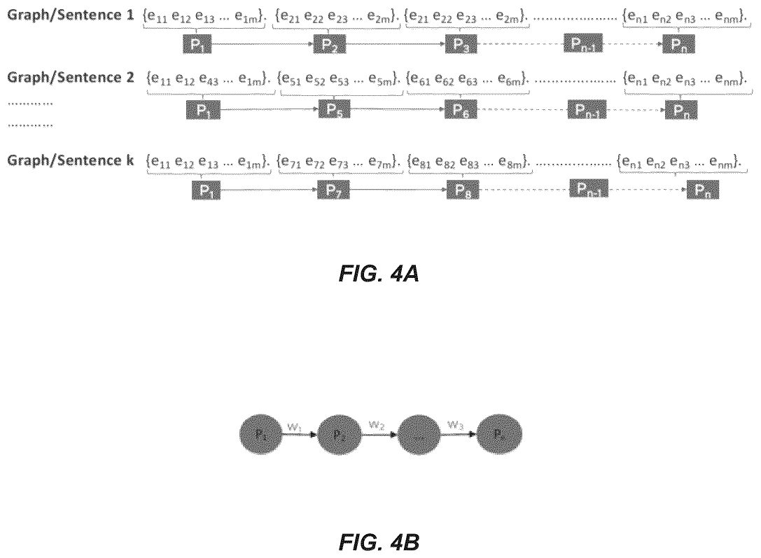

Embodiments of the disclosure may utilize any representation of computational processes to detect threats. In some embodiments, processes may be represented by the alerts or events they generate. That is, as above, sensors of, e.g., agent 200 or agent 302 may monitor network traffic of a computer network such as server cluster 100, a cloud infrastructure, an on premises infrastructure, or the like, and generate/transmit event data streams corresponding to detected network events. Events of these event streams may then be aggregated or grouped by their common computational process. Aggregated groups of events may also be referred to as a process, even though they are a representation of the underlying computational process, i.e., they are a grouping of the events generated for a process, and thus a representation of that computational process, rather than being the process itself. FIG. 4A conceptually illustrates embedding of processes for use in conjunction with embodiments of the disclosure. Here, events eₙₘ are events generated by a network sensor of, e.g., agent 200 or agent 302. Events eₙₘ of a particular computational process are grouped together to form processes Pₙ, as shown. That is, a process Pₙ is made up of a set of events eₙₘ generated by a particular computational process executed by a computer network. It is noted that the events eₙₘ of a process Pₙ are not necessarily in any order, as sequencing of system events cannot be guaranteed due to, e.g., threading, process contention, and other factors which may delay detection of some events. Furthermore, it may be desirable that no order of events eₙₘ is relied upon, as adversaries may attempt to evade detection by altering event sequences if processes Pₙ were order dependent. Accordingly, processes Pₙ may aggregate events eₙₘ in any order, regardless of the order in which events eₙₘ actually occurred or were generated.

FIG. 4B conceptually illustrates construction of paths for use in conjunction with embodiments of the disclosure. Unlike the constituent elements of processes Pₙ, a path P₁→P₂→ . . . →Pₙ is order-dependent. In particular, processes Pₙ are arranged within a path in the order in which processes Pₙ call each other. That is, in a path, each successive process Pₙ is a child of its immediately preceding process. In other words, each process is a parent process of, i.e., calls or invokes, the immediately successive process. In some embodiments of the disclosure, paths may thus be determined by, e.g., determining processes from events, storing processes in a tree structure according to parent/child relationship, and backtracking from leaf nodes/processes of the tree in depth first search manner to determine the identity and order of the processes/nodes that make up a particular path.

Embodiments of the disclosure contemplate any number, type, and order of events within a process, and any number of processes within a path (so long as order of parent/child relationships are maintained). In some embodiments, it may be desirable to limit the number of processes in a path, e.g., to 10 processes/nodes, to prevent excessive processing time, although paths of any size and number of processes are contemplated.

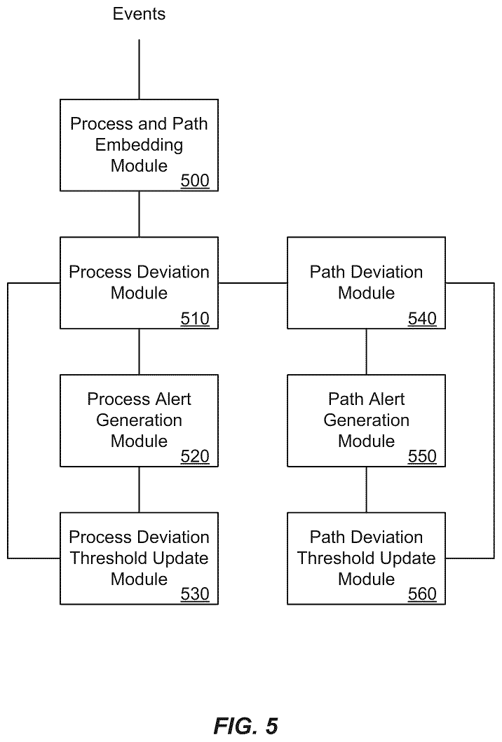

FIG. 5 is a block diagram representation of a system for context aware behavioral anomaly detection, according to embodiments of the disclosure. A process and path embedding module 500 may be in electronic communication with sensors of, e.g., agent 200 or agent 302 to receive detected events. The process and path embedding module 500 aggregates received events into processes Pₙ as above, which are embedded as vectors or any other suitable data structure for analysis by models of embodiments of the disclosure. The process and path embedding module 500 also assembles process trees or graphs as above, and determines process paths accordingly.

Processes and paths are transmitted to process deviation module 510. Module 510 compares received processes to predetermined clusters of processes, and determines one or more deviation metrics corresponding to the distance between received processes and the clusters. In some embodiments of the disclosure, process deviation module 510 includes one or more machine learning models, such as clustering models, which are trained on previous processes Pₙ detected from the same or a different computer network. Accordingly, models of process deviation module 510 may receive as inputs vector process representations, and may output one or more deviation metrics describing distances between input process vectors and the clusters determined during training of the models of module 510. In some embodiments of the disclosure, the metrics may thus include one or more distances in process vector space between the input process and one or more cluster boundaries. Any other metrics are contemplated, such as distances to other cluster boundaries, distances between specific vector elements, or any one or more other vector space distances or measures thereof.

The process deviation module 510 is programmed to compare the one or more metrics to one or more predetermined deviation threshold values. Output metric values which exceed any of these threshold values, or some combination thereof, trigger process deviation module 510 to inform process alert generation module 520, which generates an alert for users. In some embodiments, process alert generation module 520 may include code for generating a user interface. This user interface may display any received alerts as well as any other information desired by users, such as the process which caused the alert, alert date/time, or any data which may be of interest to the user. In some embodiments, alert generation module 520 may also store the generated alert and its corresponding process in any memory.

A process deviation threshold update module 530 may then update the process deviation threshold of module 510 using the process which caused the alert. Threshold updates may be performed in any suitable manner, such as by addition of the new process to the clusters and recalculation of cluster boundaries. Any manner of accounting for new processes in determination of process deviation thresholds is contemplated.

If the new input process does not result in a process alert, the latest path is input to a path deviation module 540 to determine whether any processes were called out of turn. Path deviation module 540 determines whether input paths deviate sufficiently from known or prior process paths. As shown in FIG. 4B, process paths include an ordered set of processes P₁→P₂→ . . . →Pₙ which may be viewed as a graph having nodes (processes Pᵢ) and edges (represented by arrows, as shown). In some embodiments of the disclosure, each edge is assigned a weight value wᵢ, representing the call frequency of the two associated nodes. This may be expressed as wᵢ=(#times current path was used to transition from Pᵢ to Pᵢ₊₁)/(total #times transition detected from Pᵢ to Pᵢ₊₁). That is, each weight value may be expressed as the ratio between the number of times this particular path was detected having this particular transition, to the total number of times this particular transition was detected in any path. Thus, as an example, for a path P₁→P₂→ . . . →Pₙ having a node or process P₁ which calls process P₂ (P₁→P₂), the associated weight value w₁ may be the ratio between the number of times this particular path was detected, to the total number of times P₁→P₂ has been detected in any path. Weight values wᵢ thus represent the frequency at which each process call of a path has been observed. In some embodiments of the disclosure, weight values wᵢ may be assigned by path deviation model 550, while in some other embodiments of the disclosure, weight values wᵢ may be assigned by process and path embedding module 500.

Path deviation module 540 determines one or more path deviation thresholds for comparison to the weight values wᵢ of input paths. Thresholds may be values for specific transitions between processes (e.g., from Pᵢ to Pᵢ₊₁), and may trigger an alert when exceeded. In some embodiments of the disclosure, thresholds are minimum values which trigger an alert when the corresponding weight values wᵢ fall below these thresholds. Thresholds may also be maximum values which trigger an alert when the corresponding weight values wᵢ rise above these thresholds. Threshold values may be determined in any manner. In some embodiments, certain path deviation thresholds may be determined with reference to existing known malicious processes. As one example, if a known malicious process always involves a transition from one particular process to another particular process, the threshold for that particular transition may be set to a very low value, or even to zero if that particular transition is not seen in any other benign processes. For instance, a common social media application attempting to access a device's system settings may be a known or suspected malicious process, with it further being known that this application does not attempt to access any system settings when acting benignly. Accordingly, the threshold value for this transition may be set to zero or near zero. In some embodiments, path deviation thresholds may be determined according to the frequency with which their particular transitions are seen in malicious processes. In some embodiments, path deviation thresholds may be determined according to the frequency at which their particular transitions have been seen before. In some embodiments, path deviation thresholds may be determined according to transition type, with certain transition types assigned higher (or lower) thresholds. For example, a transition into system settings, or into certain databases or other storages known to contain sensitive or confidential information, may be viewed as suspicious and assigned a low or zero threshold value, so that any attempted access automatically generates an alert. Conversely, known benign transitions may be assigned high threshold values.

Path deviation module 540 is programmed to compare its determined path weight values wᵢ to corresponding threshold values. Weight values which exceed any of these threshold values, or some combination thereof, trigger path deviation module 540 to inform path alert generation module 550, which generates an alert for users. In some embodiments, path alert generation module 550 may include code for generating a user interface. This user interface may display any received alerts as well as any other information desired by users, such as the path which caused the alert, any of its processes, alert date/time, or any data which may be of interest to the user. In some embodiments, path alert generation module 550 may also store the generated alert and its corresponding paths and/or processes in any memory.

A path deviation threshold update module 560 may then update one or more path deviation thresholds of module 540 using the path which caused the alert. Threshold updates may be performed in any suitable manner, such as by accounting for the new path transitions in recalculation of transition frequencies. Any manner of accounting for new paths or processes in determination of path deviation thresholds is contemplated. If the input path does not generate an alert, e.g., if none of its weight values exceeds a corresponding threshold value, the method of FIG. 5 may terminate, or return to module 500 for determination of new processes and paths from newly detected events.

As above, path deviation module 540 may determine path deviation according to any methods, including heuristic or rules-based methods as well as any machine learning models or methods. Heuristic models may employ any rules suitable for accurately detecting threats. As one example, threshold values may be determined for each transition between processes of a path, or for any other portion of a path. Similarly, alerts may be triggered if weight values wᵢ rise above or fall below any single threshold value, or any combination of multiple threshold values. Heuristics also are not limited to consideration of weight values wᵢ, and may also or instead be based on any other criteria. In some exemplary embodiments, path deviation may be determined at least in part by considering process deviations. For instance, if a particular path Pₐ→ →Pₙ has a high transition probability, i.e., is a commonly occurring path, and if Pₐ≈P_{b}, i.e., if the distance between Pₐ and P_{b} is small in process vector space, and if P_{b}→ . . . →Pₙ has never been observed, then it may be inferred that P_{b}→ . . . →Pₙ is not an anomalous transition. In other words, when a new process initiates a commonly occurring benign path, and this new process is very similar to the original process which initiated the path, it is likely that users have simply chosen a new application to carry out a common benign path, e.g., users have simply chosen a new browser to carry out a task or set of tasks they often perform. Accordingly, one heuristic may entail disregarding this set of circumstances when it is detected. Furthermore, process distances may be used in path deviation heuristics in any manner.

Also as above, process deviation module 510 may determine process clusters in any manner. In some embodiments, process deviation module 510 employs one or more machine learning models to determine process clusters. As an example, any clustering models may be employed, such as K-means models, Density-Based Spatial Clustering of Applications with Noise (DBSCAN) models, Gaussian Mixture Models (GMM), hierarchical clustering models, or the like. Embodiments of the disclosure also contemplate determination of clusters of processes in any other manner besides those employing machine learning models.

It is noted that the various modules of FIG. 5 are shown as separate and distinct modules for purposes of clarity and ease of explanation of the various functions of embodiments of the disclosure. One of ordinary skill in the art will observe, however, that these modules may be combined or distributed in any suitable manner. As one nonlimiting example, each of the modules may be incorporated within a single program, such as an application program, to be executed by any computing device of, e.g., server cluster 100.

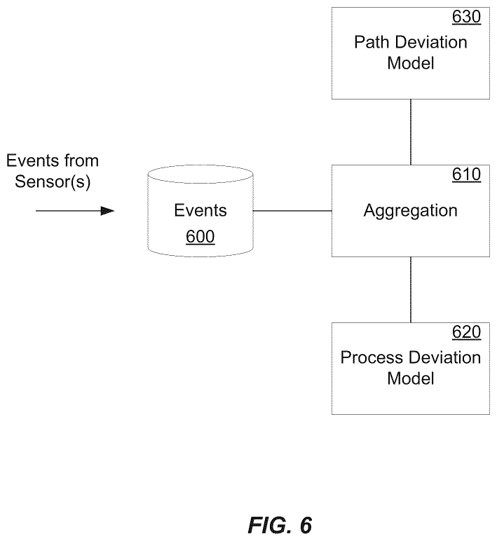

Some embodiments of the disclosure may entail training of process and/or path deviation models. FIG. 6 is a block diagram representation of a system for training of models for context aware behavioral anomaly detection, according to embodiments of the disclosure. Storage 600 may store events generated by sensors. Stored events may subsequently be transmitted to aggregation module 610, which is a module similar in function to process and path embedding module 500. Aggregation module 610 embeds events into vectors representing processes, as well as orders and aggregates processes into paths, as above. In some embodiments, storage 600 stores a training set of predetermined processes and paths, and aggregation module 610 is not required. For supervised path deviation models, stored predetermined paths may be labeled as being benign or representing threats. Aggregation module 610 may transmit these stored path training data sets to path deviation model 630 and initiate training accordingly.

Aggregation module 610 transmits its assembled process vectors to process deviation model 620, and clusters the input training set in known manner. If path deviation model 630 employs machine learning methods requiring training, aggregation module 610 also transmits is determined paths to path deviation model 630 whereupon training of the model 630 is carried out in known manner. Process deviation model 620 thereby has a number of cluster boundaries determined and is thus configured to output, from input process vectors, outputs that can include whether input vectors lie within a cluster or not, distances between input process vectors and cluster boundaries, likelihoods of lying within clusters (e.g., when GMMs or other statistical models are employed), and the like. For path deviation models 620, inputs may include paths, and outputs may include likelihoods of whether input paths or any portions thereof represent threats, rules violated, and the like.

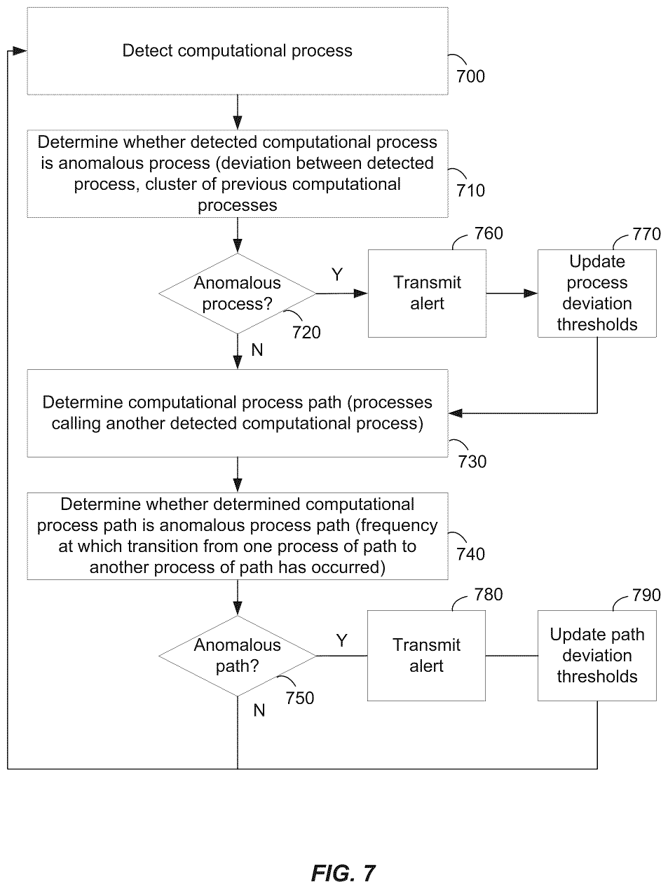

FIG. 7 is a flow chart depicting a method for context aware behavioral anomaly detection, according to embodiments of the disclosure. Initially, at step 700, computational processes carried out by one or more programs executed on a distributed computing system such as that shown in FIG. 1 are detected. More specifically, sensors of, e.g., agent 200 or agent 302 of a computing network generate events and transmit them to a process and path embedding module 500, which maps them to processes. Next, at step 710, process deviation module 510 may determine whether a detected computational process is an anomalous process, according to a deviation between the detected process and clustered processes. Process deviation module 510 may implement a process deviation model 620 and input processes thereto, where this model 620 is trained to determine distances between those processes and predetermined clusters of processes previously carried out on the computing network, or processes representative thereof. The process deviation model 620 thus measures the deviation in input processes from these process clusters. At step 720, measured deviations are compared to one or more threshold values, which may be distances in process vector space, to determine whether the input process is considered an anomalous process. In some embodiments, deviations exceeding the predetermined threshold value(s) are considered sufficiently different from known or accepted processes (i.e., process clusters) that the input process is considered anomalous, and thereby a potential threat. Thus, at step 760, an alert may be transmitted to, e.g., a user to prompt inspection of the process and any desired remedial action. At step 770, the process may then be used to update the process deviation threshold, such as by reducing the threshold for future processes identical or similar to the process for which an alert was generated.

Once step 770 is complete, or if the input process is determined to be benign, i.e., its distance in process vector space from one or more clusters is sufficiently small that it does not exceed any applicable threshold value, the corresponding path is input to path deviation model 630 to measure its deviation(s) from acceptable paths. More specifically, at step 730, process and path embedding module 500 determines computational process paths comprising sets of determined processes. Paths are made up of sequences of computational processes that each call each other. That is, process and path embedding module 500 maps events to processes as above, then determines parent/child relationships therebetween, and backtracks those relationships to determine process paths.

Once a process path is determined, path deviation module 540 determines, at step 740, whether the determined computational process path is an anomalous process path, according to a frequency at which a transition from one process of the path to another process of the path has occurred. Weight values may be determined for process transitions of the input path, corresponding to frequencies at which those process calls or transitions occur. At step 750, one or more weight values are compared to predetermined threshold values to determine whether the process call is considered anomalous. Alternatively, weight values or paths may be compared to heuristics, or input to a machine learning model, to determine whether an anomalous process has occurred. If so, at step 780, a path deviation alert is generated and transmitted to the user. At step 790, the input path may also be used to update any path deviation thresholds, such as by changing the threshold for any corresponding weight values. Once step 790 is complete, or if the input path is not determined to be anomalous, the method may return to step 700 to repeat for further detected processes.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings. One of ordinary skill in the art will also understand that various features of the embodiments may be mixed and matched with each other in any manner, to form further embodiments consistent with the disclosure.

What is claimed is:

1. A method of detecting anomalous behavior in a distributed computing system, the method comprising:
detecting a computational process carried out by one or more programs executed on the distributed computing system;
determining whether the detected computational process is an anomalous computational process, according to a deviation between the detected computational process and a cluster of previously detected computational processes;
determining a computational process path comprising a plurality of the detected computational processes, each detected computational process of the plurality of the detected computational processes calling another detected computational process of the plurality of the detected computational processes;
determining whether the determined computational process path is an anomalous computational process path, according to a frequency at which a transition from one process of the computational process path to another process of the computational process path has occurred; and
transmitting an alert in response to determining that the detected computational process is an anomalous computational process, and in response to determining that the detected computational process path is determined to be an anomalous computational process path.

2. The method of claim 1, wherein the determining whether the determined computational process path is an anomalous computational process path is performed responsive to a determination that the detected computational process is not an anomalous computational process.

3. The method of claim 1, wherein the computational processes each comprise a plurality of events generated by a sensor of the distributed computing system.

4. The method of claim 1, wherein the computational process path further comprises an ordered sequence of the computational processes, each computational process of the computational process path being a parent process of the immediately successive computational process in the ordered sequence.

5. The method of claim 1, wherein, for a plurality of the determined computational process paths, the frequency is determined according to a number of transitions from the one process to the another process in each of the determined computational process paths, and a total number of detected transitions from the one process to the another process.

6. The method of claim 1, wherein the determining whether the detected computational process path is an anomalous computational process path further comprises determining whether the detected computational process path is an anomalous computational process path according to a comparison of the frequency to one or more predetermined criteria.

7. The method of claim 1, wherein the determining whether the detected computational process path is an anomalous computational process path further comprises determining whether the detected computational process path is an anomalous computational process path according to a difference between the one process of the computational process path and a corresponding process of a previously determined computational process path.

8. The method of claim 1, wherein the determining whether the detected computational process path is an anomalous computational process path further comprises determining whether the detected computational process path is an anomalous computational process path according to one or more machine learning models, the one or more machine learning models having as an input the determined computational process path and having as an output a likelihood that the input computational process path is an anomalous computational process path.

9. The method of claim 8, wherein the one or more machine learning models are trained using ones of the computational process paths labeled as anomalous computational process paths and ones of the computational process paths labeled as non-anomalous computational process paths.

10. The method of claim 1, wherein the determining whether the detected computational process is an anomalous computational process further comprises determining whether the deviation between the detected computational process and a cluster of previously detected computational processes exceeds a predetermined deviation threshold.

11. The method of claim 10, further comprising updating the deviation threshold using the detected computational process.

12. The method of claim 1, wherein the determining whether the determined computational process path is an anomalous computational process path further comprises determining whether the frequency at which a transition from a process of the computational process path to another process of the computational process path has occurred is less than a predetermined frequency threshold.

13. The method of claim 12, further comprising updating the frequency threshold using the determined computational process path.

14. The method of claim 12, further comprising determining the frequency threshold at least in part from one or more previously determined malicious computational processes.

15. A non-transitory computer-readable storage medium storing instructions configured to be executed by one or more processors of a computing device, to cause the computing device to carry out steps that include:
detecting a computational process carried out by one or more programs executed on the distributed computing system;
determining whether the detected computational process is an anomalous computational process, according to a deviation between the detected computational process and a cluster of previously detected computational processes;
determining a computational process path comprising a plurality of the detected computational processes, each detected computational process of the plurality of the detected computational processes calling another detected computational process of the plurality of the detected computational processes;
determining whether the determined computational process path is an anomalous computational process path, according to a frequency at which a transition from one process of the computational process path to another process of the computational process path has occurred; and
transmitting an alert in response to determining that the detected computational process is an anomalous computational process, and in response to determining that the detected computational process path is determined to be an anomalous computational process path.

16. The non-transitory computer-readable storage medium of claim 15, wherein the instructions, when executed by the one or more processors of the computing device, further cause the computing device to carry out steps that include:
determining whether the detected computational process is an anomalous computational process further comprises determining whether the deviation between the detected computational process and a cluster of previously detected computational processes exceeds a predetermined deviation threshold.

17. The non-transitory computer-readable storage medium of claim 15, wherein the instructions, when executed by the one or more processors of the computing device, further cause the computing device to carry out steps that include:
determining whether the frequency at which a transition from a process of the computational process path to another process of the computational process path has occurred is less than a predetermined frequency threshold.

18. A computer system, comprising:
one or more processors; and
memory storing one or more programs configured to be executed by the one or more processors, the one or more programs including instructions for:
detecting a computational process carried out by one or more programs executed on the distributed computing system;
determining whether the detected computational process is an anomalous computational process, according to a deviation between the detected computational process and a cluster of previously detected computational processes;
determining a computational process path comprising a plurality of the detected computational processes, each detected computational process of the plurality of the detected computational processes calling another detected computational process of the plurality of the detected computational processes;
determining whether the determined computational process path is an anomalous computational process path, according to a frequency at which a transition from one process of the computational process path to another process of the computational process path has occurred; and
transmitting an alert in response to determining that the detected computational process is an anomalous computational process, and in response to determining that the detected computational process path is determined to be an anomalous computational process path.

19. The system of claim 18, wherein the one or more programs further include instructions for:
determining whether the detected computational process is an anomalous computational process further comprises determining whether the deviation between the detected computational process and a cluster of previously detected computational processes exceeds a predetermined deviation threshold.

20. The system of claim 18, wherein the one or more programs further include instructions for:
determining whether the frequency at which a transition from one process of the computational process path to another process of the computational process path has occurred is less than a predetermined frequency threshold.
